(19) United States
(12) Patent Application Publication
(10) Pub. No.: US 2016/0062387 A1
(43) Pub. Date: Mar. 3, 2016

(54) CONTROLLER

(71) Applicants: Martin Hugh BOUGHTWOOD, (US); DEREGALLERA HOLDINGS LTD, Cardiff (GB)

(72) Inventor: Martin Hugh BOUGHTWOOD, Cardiff (GB)

(73) Assignee: DEREGALLERA HOLDINGS LTD, Cardiff, SG (GB)

(21) Appl. No.: 14/782,528

(22) PCT Filed: Mar. 27, 2014
(86) PCT No.: PCT/GB2014/050974

§ 371 Date: Oct. 5, 2015

(30) Foreign Application Priority Data
Apr. 8, 2013 (GB) 1306293.0

(51) Int. Cl. G05G 9/047; G01D 5/241; B60R 16/02; B62D 1/12

(52) U.S. Cl. CPC G05G 9/047; B62D 1/12; G01D 5/2417; B60R 16/02; G05G 2009/04762

(57) ABSTRACT

A controller for converting a force applied by a user in at least one direction into an output indicative of the force applied, comprising: a support comprising a first part of a capacitor assembly; and a user-engageable part resiliently coupled to the support and comprising a second part of the capacitor assembly, wherein movement of the user-engageable part relative to the support varies the capacitance of the capacitor assembly; characterised in that the user-engageable part is substantially immovable relative to the support in the at least one direction.

The present invention relates to a controller and particularly, but not exclusively, to controllers for use in controlling a vehicle (e.g. wheel-driven vehicle or other type of vehicle).

Wheel-driven vehicles such as passenger cars, delivery vans, buses, lorries, etc are typically designed around requirements that have evolved through time and which still perpetuate functions that may not be the most ideal for a new generation of vehicle. Electrically-powered wheel-driven vehicles, especially those in which the drive motor is incorporated within the wheel or local to the wheel, provide for a substantial degree of vehicle design freedom. One area of freedom is in the area of driver control interface. Historically this has been a combination of controls including a steering wheel, a throttle pedal, a clutch pedal, a gear stick and a brake pedal. These functions have historically been essential in order to deal with the mechanical systems to which they relate.

There have been a number of examples of displacement joystick type controllers for electric vehicles applied to such things as wheelchairs, earthmoving equipment and more recently passenger cars. Furthermore, variable capacitance electrostatic displacement joysticks have been proposed for as vehicle controllers, for example as disclosed in U.S. Pat. No. 5,421,694.

Problems with solutions proposed in the art have related to: ergonomics and fatigue (the user must hold the joystick in one of a plurality of different positions to provide different inputs which may be uncomfortable to the user over a prolonged period); difficulty in maintaining a control position when the vehicle moves over rough or bumpy ground; inadequate safety/redundancy; and difficulty in controlling more than one demand parameter with the same input device.

The present applicant has identified the need for an improved controller that overcomes or at least alleviates problems associated with the prior art.

In accordance with a first aspect of the present invention, there is provided a controller (e.g. joystick) for converting a force applied by a user in at least one direction (e.g. linear direction or rotary direction) into an output indicative of the force applied, comprising: a support comprising a first part of a capacitor assembly; and a user-engageable part (e.g. handle or knob) resiliently coupled to the support and comprising a second part of the capacitor assembly, wherein movement of the user-engageable part relative to the support varies the capacitance of the capacitor assembly; characterised in that the user-engageable part is substantially immovable relative to the support in the at least one direction (e.g. with movement of the user-engageable part relative to the support being substantially imperceptible to the user).

In this way, a controller is provided that allows a user to provide a full range of force inputs with their arm/hand in a fixed position relative to the controller thereby allowing use of the controller in a relaxed position whilst avoiding the need for repetitive wrist movement. Advantageously, the controller of the present invention may be used to control manoeuvring of a vehicle (e.g. steering, acceleration and braking) whilst overcoming problems associated with prior art joystick controllers maintaining a desired joystick position when going over rough terrain and problems with user fatigue. Furthermore, the substantially fixed user-engageable part may be of a robust construction and used by a user to brace themselves (e.g. in a collision or during sudden breaking).

In one embodiment, linear displacement (e.g. during pivotal movement) of the user-engageable part relative to the support is limited to a range of less than 1 mm (e.g. less than 0.1 mm).

In one embodiment, the first part of the capacitor comprises a first conductor region (e.g. first electrode plate) of the capacitor. In one embodiment, the first conductor region may be electrically connected to ground.

In one embodiment, the second part of the capacitor comprises a second conductor region (e.g. second electrode plate) of the capacitor.

In one embodiment, a full range of outputs is achieved by varying spacing between the first and second conductor regions by less than 1 mm (e.g. less than 0.1 mm).

In one embodiment, the support comprises an elongate section (e.g. shaft) having a first end to which the user-engageable part is resiliently coupled.

In one embodiment, the user-engageable part comprises a substantially circular or substantially spherical body configured to be grasped by a user's hand.

In one embodiment, the first and second conductor regions are separated by a resilient dielectric layer (e.g. providing at least in part the resilient coupling between the user-engageable part and the support).

In one embodiment, the resilient dielectric layer is a flexible silicon rubber layer or similar material.

In another embodiment, the resilient coupling between the user-engageable part and the support may be provided by an external resilient force (e.g. in the case that the dielectric layer is a fluid).

In one embodiment, the user-engageable part is substantially more resistant to movement in a direction perpendicular to the at least one direction that it is resistant to movement in the at least one direction.

In one embodiment, the user-engageable part is configured to additionally convert a force applied by a user in a further direction (e.g. second direction) into an output indicative of the force applied in the further direction and the user-engageable part is substantially immovable relative to the support in the further direction.

In one embodiment, the first-defined direction is a linear direction and the further direction is a rotary direction.

In one embodiment, the support further comprises a first part of a second capacitor assembly and the user-engageable part comprises a second part of the second capacitor assembly.

In one embodiment, the first part of the second capacitor assembly is a first conductor region. The first conductor region of the second capacitor and the first conductor region of the first capacitor may be provided by a common conductor part or by discrete conductor parts. The first conductor region of the second capacitor may be electrically connected to ground.

In one embodiment, the second part of the second capacitor assembly is a second conductor region (e.g. second electrode plate).

In one embodiment, the further (i.e. rotary) direction corresponds to an axis of rotation substantially perpendicular to the first direction and the second capacitor assembly is spaced from the first capacitor assembly in a third direction substantially parallel to the axis of rotation.

In one embodiment, the support further comprises a first part of a third capacitor assembly and the user-engageable part comprises a second part of the third capacitor assembly, with the third capacitor being spaced from the first capacitor assembly in the first direction.

In one embodiment, the support further comprises a first part of a fourth capacitor assembly and the user-engageable part comprises a second part of the fourth capacitor assembly, with the fourth capacitor being spaced from the second capacitor assembly in the first direction.

In accordance with a second aspect of the present invention, there is provided a vehicle control device comprising a controller (e.g. joystick) for converting a force applied by a user in at least one direction (e.g. linear direction or rotary direction) into an output indicative of the force applied, the controller comprising: a support; and a user-engageable part (e.g. handle or knob) resiliently coupled to the support, wherein movement of the user-engageable part relative to the support varies an electrical property of a part of the controller;

characterised in that the user-engageable part is substantially immovable relative to the support in the at least one direction (e.g. with movement of the user-engageable part relative to the support being substantially imperceptible to the user).

In one embodiment, linear displacement of the user-engageable part relative to the support is limited to a range of less than 1 mm (e.g. less than 0.1 mm).

In one embodiment, the controller is a controller as previously defined (i.e. an electrostatic controller).

In another embodiment, the controller includes a strain gauge having an electrical resistance that changes with the position of the user-engageable part relative to the support.

In one embodiment, the controller is configured to detect the presence of the user's hand on the user-engageable part (e.g. by means of a touch capacitor or by software configured to monitor output from the controller and trigger a hand removal signal if no change in output is detected within a predetermined period). In the case of software monitoring, left and right steering inputs may be monitored since there is a generally a continual need to adjust for road conditions. In one embodiment, the predetermined period may vary with speed.

In one embodiment, the controller is configured to sustain a last output level applied by a user for as long as the presence of the user's hand is detected on the user-engageable part.

In one embodiment, the output level is sustained until a subsequent force greater than the last force is applied in the same direction as the last force or until a subsequent force in an opposed direction to the last force is applied. In the case of a subsequent force applied in an opposed direction to the last force, the output may be reduced at a rate proportional to the subsequent force applied.

In one embodiment, in response to detecting removal of a user's hand from the user-engageable part the output is gradually reduced (e.g. to zero). In this way, a controlled deceleration/steering output moving slowly to a straight ahead condition will occur when a user's hand is removed from the user-engageable part. Return of the user's hand to the user-engageable part causes the outputs to stay at the levels that existed immediately prior to the return of the user's hand.

In one embodiment, the vehicle control device is configured to generate a steering output in response to a force applied in a rotary direction.

In one embodiment, the vehicle control device is configured to generate a tractive force demand output in response to a rearward force.

In one embodiment, the vehicle control device is configured to generate a breaking force demand output in response to a force in a forward direction. In this way, if a user is thrown forward whist holding the user-engageable part the controller may act to assist breaking of the vehicle.

In one embodiment, the vehicle control device is configured to generate both a positive output indicative of a force input in a first direction (e.g. linear or rotary direction) and a negative output indicative of a force input in a direction opposed to the first direction. In this way, in the event of an output channel being lost (e.g. as a result of a fault in the electronics or cabling fault), a receiving control system can make use of the negative output value in the opposed direction to represent the desired output.

Embodiments of the present invention will now be described by way of example with reference to the accompanying drawings in which:

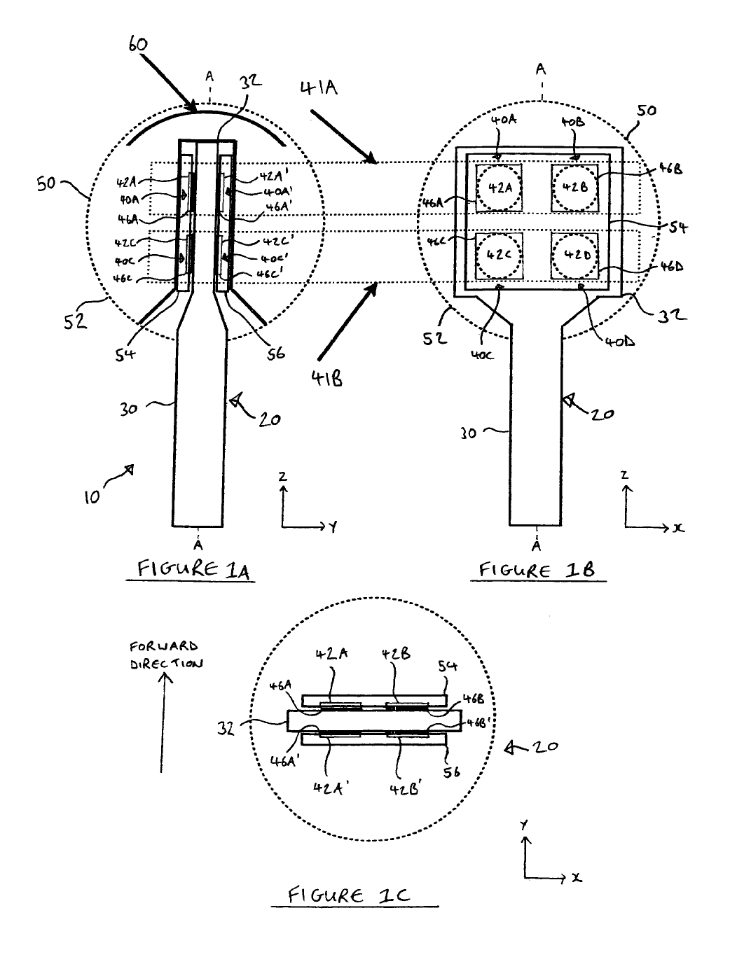

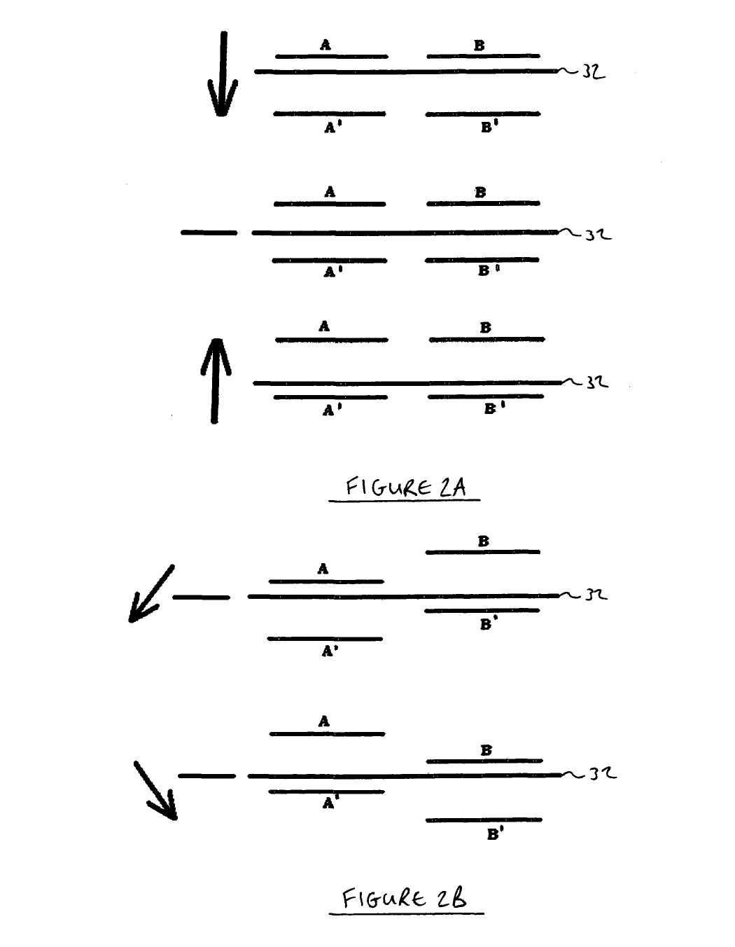

FIG. 1A shows a schematic cross-sectional side view of a vehicle control device in accordance with a first embodiment of the present invention;

FIG. 1B shows a schematic front view of the vehicle control device of FIG. 1A:

FIG. 1C shows a schematic plan view of the vehicle control device of FIG. 1A;

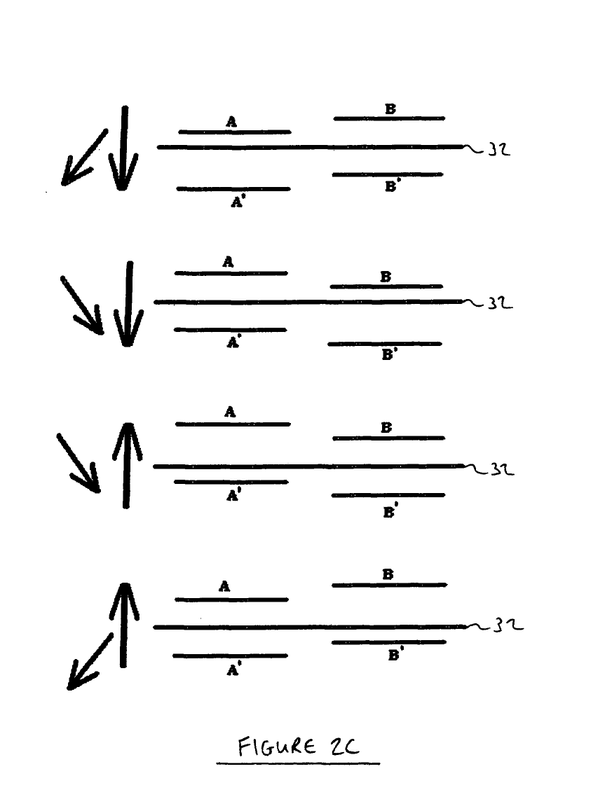

FIGS. 2A-C illustrate operation of the vehicle control device of FIG. 1A in response to a variety of force inputs;

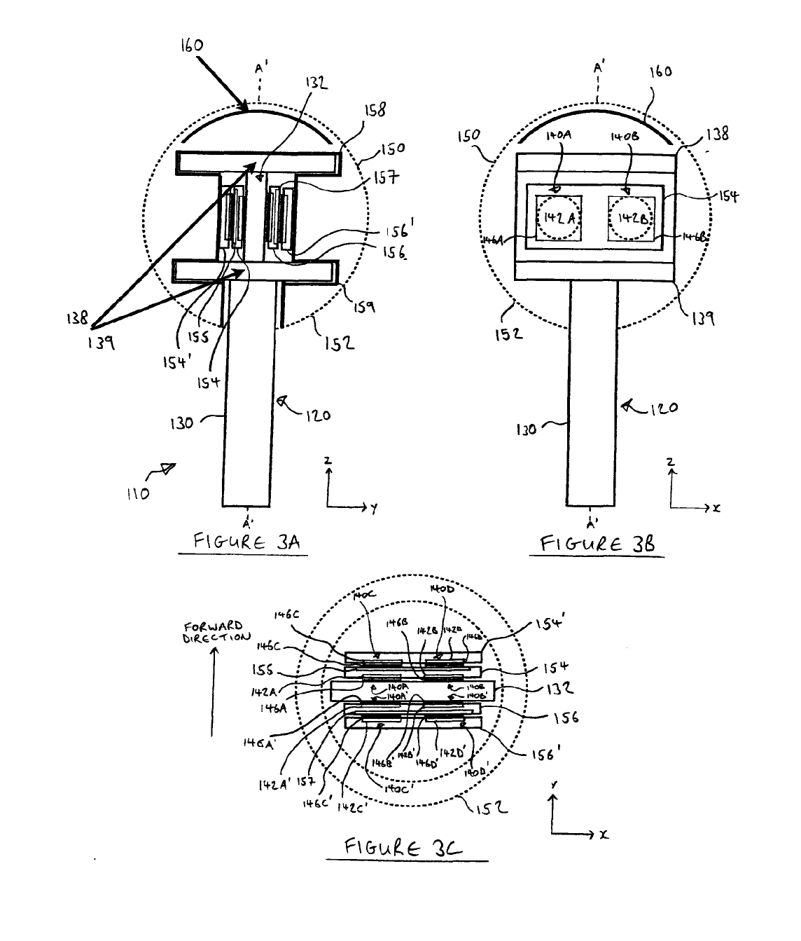

FIG. 3A shows a schematic cross-sectional side view of a vehicle control device in accordance with a second embodiment of the present invention;

FIG. 3B shows a schematic front view of the vehicle control device of FIG. 3A:

FIG. 3C shows a schematic plan view of the vehicle control device of FIG. 3A; and

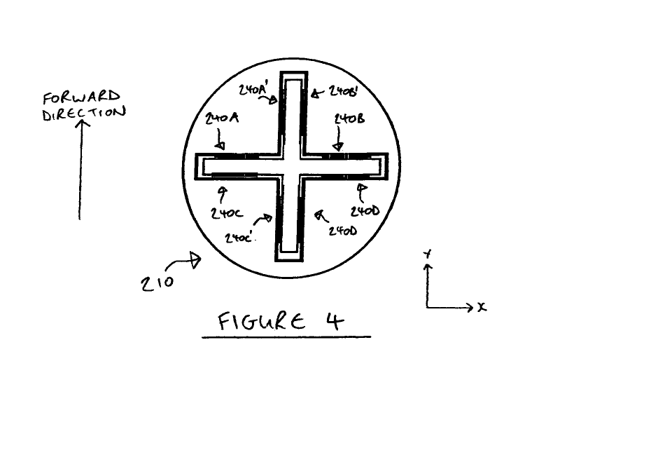

FIG. 4 shows a schematic plan view of a vehicle control device in accordance with a third embodiment of the present invention.

FIGS. 1A-1C show a vehicle control device 10 comprising a force joystick 20 for converting a force applied by a user in at least one direction (in this case in a linear direction parallel the y axis or in a rotary direction corresponding to an axis of rotation parallel to the z axis depending upon the type of input required by a user) into an output indicative of the force applied.

Force joystick 20 comprises a robust support in the form of elongate shaft 30 (having a longitudinal axis “A”) and a user-engageable handle (or knob) 50 comprising a body 52 that is resiliently coupled to shaft 30.

Shaft 30 includes an electrically conductive plate portion 32 extending into handle 50. Plate portion 32 is electrically connected to ground to form a ground electrode of a first set of capacitor assemblies 40A-D on a first side of the shaft and of a second set of capacitor assemblies 40A′-D′ on a second side of the shaft opposed to the first side of the shaft. In this example, shaft 30 is intended to be mounted substantially vertically in a vehicle and positioned to allow handle 50 to be grasped by driver's hand while the driver is driving the vehicle (e.g. with the driver being in a seated position). As illustrated, the capacitor assemblies are divided into a first (or upper) set of sensors 41A and a second (or lower) set of sensors 41B).

Body 52 has a substantially spherical outer profile and houses first and second printed circuit boards (PCBs) 54, 56 mounted on the opposed sides of plate portion 32 of shaft 30. First PCB 54 includes a first array of electrode pads 42A-D forming part of the first set of capacitor assemblies 40A-D and second PCB 56 includes a second array of electrode pads 42A′-D′ forming part of the second set of capacitor assemblies 40A′-D′. Optionally, each of the first and second PCBs 54, 56 may include a driven screen layer (e.g. copper mesh layer) formed therein for for negating stray capacitance. As illustrated, adjacent pairs of electrode pads 42A/B, 42C/D, 42A7B′ and 42C′/D′ are positioned along the x axis either side of longitudinal axis “A” whereby rotation of handle 50 relative to shaft 30 around axis “A” will result in movement of the electrode pads in each adjacent pair moving in opposed direction along the y axis. The sensor configuration is such to provide complete (100%) redundancy in each direction of control and compensation for environmental influences such as temperature and EMI.

Resilient coupling between handle 50 and shaft 30 is achieved by means of: a first set of resilient dielectric layer pads 46A-D each having a first side bonded to the first PCB 54 to cover a respective electrode pad 42A-D and second side bonded to plate portion 32; and a second set of resilient dielectric layer pads 46A′-D′ each having a first side bonded to the second PCB 56 to cover a respective electrode pad 42A′-D′ and second side bonded to plate portion 32. In one embodiment, the resilient dielectric layer pads 46A-D/46A′-D′ each comprise a flexible silicon rubber layer or similar dielectric material with the restoring force being achieved exclusively by the elasticity of the dielectric material. In the case of a silicon rubber type material, all electrode areas may be completely sealed from the atmosphere and not subject to any change due to humidity, etc.

In use, movement of handle 50 relative to shaft 30 along the x axis varies the capacitance of each capacitor assembly in the array of capacitor assemblies 40A-H by varying spacing between electrode pads 42A-D/42A′-D′and plate portion 32. Unlike a conventional displacement joystick having a joystick handle that is movable between a plurality of observable displacement positions, handle 50 is substantially immovable relative to shaft 30 in the at least one direction (e.g. with movement of the user-engageable part relative to the support being substantially imperceptible to the user) and produces an output in proportion to the force applied by the user without noticeable movement of handle 50. Typically, a full range of outputs are achieved by varying spacing between electrode pads 42A-D/42A′-D′and shaft 30 by less than 1 mm (e.g. less than 0.1 mm) and accordingly linear displacement of handle 50 relative to the shaft is similarly limited.

The resilient dielectric layer pads 46A-D/46A′-D′ may have a thickness that is less than 1 mm (e.g. a thickness of typically around 0.1 mm). The movement that alters the capacitance of the capacitor assemblies results from a change in thickness of the dielectric material due to a force being applied to handle 50. The movement is self-limiting and exponential.

As will be evident to the skilled reader, the thicker the dielectric compliant material the lower the capacitance, so the electrode area would beneficially be large to have the best signal level. However, the thicker dielectric results in less force being required to displace the electrodes pads 40A-D/40A′-D′ closer to support 30.

It can also be seen that the elasticity of the dielectric material, the thickness and the electrode area all play a part in setting the response characteristic of the device so that the anticipated input forces for any specific application are optimally detected with the maximum level of output signal.

Similarly the output is exponential with respect to displacement distance: the closer the electrodes come together the greater the increase in capacitance per unit of separation distance. For example, if the starting capacitance is 1 nF and the material is subsequently compressed to half its original 0.1 thickness, the capacitance doubles to 2 nF (that is a capacitance change of 1 nF per 0.05 mm). If the material is further compressed to a thickness of 0.025 mm then the capacitance will again double to 4 nF giving an overall capacitance change of 3 nF/0.075 mm. Whilst this increase in sensitivity of displacement is occurring, the force needed to achieve the displacement gets larger and larger. Thus the device can withstand increasing forces and provide an output that remains in proportion to the force. This is unlike a strain gauge for example which as a linear output to input and cannot accept inputs that do not follow a limited linear profile.

As illustrated in FIG. 2A-C, the direction of the input force applied by the user is determined by comparing the capacitance of adjacent pairs of electrode pads. The diagrams are schematically depicting upper pairs of capacitor assemblies 40A-B and 40A′-B′ (first sensor set 41A) viewed from above (i.e. looking down along the z axis); operation of the lower pairs of capacitor assemblies 40C-D and 40C′-D′ (second sensor set 41B) correspond and are intended to provide redundancy in each direction of control in case of failure of any of the corresponding upper capacitor assemblies.

As illustrated in FIG. 2A, a zero input force is associated with handle 50 being located centrally between opposed adjacent pairs of electrode pads (as illustrated in the central illustration). In this orientation, spacing between each electrode pad and the handle is the same resulting in an equal capacitance measurement for each capacitor assembly.

If an input force is applied by a user in a rearward direction (e.g. an input in the negative y direction as shown in the upper illustration of FIG. 2A), spacing between each adjacent electrode pad 42A and 42B and shaft 30 decreases equally as resilient dielectric layer pads 46A and 46B are compressed in response to the input force, with the decrease in spacing causing capacitance measured between each electrode pad 42A/42B and the shaft 30 to increase. At the same time, spacing between each adjacent electrode pad 42A′ and 42B′ and shaft 30 increases equally as resilient dielectric layer pads 46A′ and 46B′ stretch in response to the input force, with the increase in spacing causing capacitance measured between each electrode pad 42A′/42B′ and the shaft 30 to decrease. When an input force is applied by a user in a forward direction (e.g. in the positive y direction as shown in the lower illustration of FIG. 2A), the change in capacitance for each capacitor assembly reverses. In each case the magnitude of the output would be proportional to the applied force and would result in a braking/deceleration demand in proportion to the full scale level. In one embodiment, an input force applied in the rearward direction is interpreted by the vehicle control device 10 as an accelleration input and an input force applied in the forward direction is interpreted as a braking input. In this way, if a user is thrown forward whist holding the user-engageable part the controller may act to assist breaking of the vehicle. Of course, the directionality of the vehicle control device 10 could be reversed.

FIG. 2B illustrates how force joystick 20 may be additionally used to provide left and right steering control. For simplicity, tilting of the electrode pads relative to support 30 is not shown, even though tilting will occur to some degree. The effect of tilt is balanced between sensor pads that are closer together and those further apart, therefore any effect is negligible as the control system simply sees the average capacitance (i.e. as though the plates were parallel but at some average distance).

As shown in the upper illustration, a rotational anticlockwise input force around longitudinal axis “A” results in movement of adjacent electrode pads 42A/B and 42A7B′ in opposed directions relative to shaft 30 with the spacing between electrode pads 42A and 42B′ decreasing equally as resilient dielectric layer pads 46A and 46B′ are compressed in response to the input force, and with spacing between electrode pads 42B and 42A′ increasing equally as resilient dielectric layer pads 46B and 46A′ expand in response to the input force. The resulting difference in measured capacitance between adjacent capacitor assemblies 40A/B and 40A′B′ is interpreted by the vehicle control device 10 as a steering input to the left. Similarly, a rotational clockwise input force (as shown in the lower illustration) results in an opposed change in capacitance that is interpreted as a steering input to the right.

FIG. 2C illustrates schematically the result of a combined force input in the y direction and a rotational force input around longitudinal axis “A” (i.e. a combined braking/acceleration input and steering input). The following calculations allow the vehicle control device 10 to determine the relevant braking acceleration input and steering input from the measured capacitances of the capacitor assemblies 40A-B and 40A′-B′:

Braking/acceleration input calculation:

(40A+40B)−(40A′+40B′)=signed force value

Steering input calculation:

40A−40B=signed steering value

In addition to capacitor assemblies 40A-D and 40A′-D′, force joystick 20 additionally comprises a touch capacitor 60 located on an uppermost part of body 52 configured to detect the presence of the user's hand on handle 50. The vehicle control device 10 is configured to sustain a last output level applied by a user for as long as the presence of the user's hand is detected on handle 50. The last output level is sustained until a subsequent force greater than the last force is applied in the same direction as the last force or until a subsequent force in an opposed direction to the last force is applied. In the case of a subsequent force applied in an opposed direction to the last force, the output is reduced at a rate proportional to the subsequent force applied.

In response to detecting removal of a user's hand from handle 50, the output is gradually reduced (e.g. to zero over a time period that is configurable to suit the characteristics of the vehicle). In this way, a controlled deceleration/steering output moving slowly to a straight ahead condition will occur when a user's hand is removed from handle 50. Return of the user's hand to handle 50 causes the outputs to stay at the levels that existed immediately prior to the return of the user's hand.

In one embodiment, the output from the vehicle control device 10 may include dual signals to allow operation if one fails. For example, after the capacitance has been measured, a positive output for acceleration may be accompanied by a negative output value for braking. In the event of the acceleration channel being lost through electronics or cabling faults for example, the receiving control system can make use of the negative braking value value to represent a positive acceleration value. This would be an emergency condition but will provide further level of safety and redundancy. In the potentially more critical situation that a braking signal were to be affected by such a fault condition, the braking value can be derived from a negative acceleration signal generated by the vehicle control device.

FIGS. 3A-C show a vehicle control device 110 comprising a force joystick 120 which is based on the principle of force joystick 20 for converting a force applied by a user in at least one linear/rotary direction into an output indicative of the force applied but with an alternative sensor configuration for providing redundancy in all input directions.

Force joystick 120 comprises a robust support in the form of elongate shaft 130 (having a longitudinal axis “A′”) and a user-engageable handle (or knob) 150 comprising a body 152 that is resiliently coupled to shaft 130.

Shaft 130 includes an electrically conductive plate 132 that is electrically connected to ground to form a ground electrode of a first pair of inner capacitor assemblies 140A, 140B on a first side of shaft 130 and of a second pair of inner capacitor assemblies 140A′, 140B′ on a second side of shaft 130 opposed to the first side of the shaft.

Body 152 has a substantially spherical outer profile and houses first and second inner printed circuit boards (PCBs) 154, 156 mounted on the opposed sides of shaft 130 and first and second outer PCBs 154′, 156′ mounted in a “piggy back” configuration as described below.

First inner PCB 154 includes on a first side thereof facing shaft 130 a first pair of electrode pads 142A, 142B forming parts of the first pair of inner capacitor assemblies 140A, 140B respectively and second inner PCB 156 includes (again on a first side thereof facing shaft 130) a second pair of inner electrode pads 142A′, 142B′ forming parts of the second pair of inner capacitor assemblies 140A′, 140B′ respectively. The first inner PCB 154 further includes on a second side opposed to the first side a first conductor plate 155 that is electrically connected to ground to form a ground electrode of a first pair of outer capacitor assemblies 140C, 140D on the first side of shaft 130. Similarly, the second inner PCB 156 further includes on a second side opposed to the first side a second conductor plate 157 that is electrically connected to ground to form a ground electrode of a second pair of outer capacitor assemblies 140C′, 140D′ on the second side of shaft 130.

First outer PCBs 154′ is mounted to body 152 and includes on a first side thereof facing shaft 130 a first pair of electrode pads 142C, 142D forming parts of the first pair of outer capacitor assemblies 140C, 140D respectively and second outer PCB 156′ includes (again on a first side thereof facing shaft 130) a second pair of electrode pads 142C′, 142D′ forming parts of the second pair of outer capacitor assemblies 140C′, 140D′ respectively.

As before, each of the first and second inner PCBs 154, 156 and each of the first and second outer PCBs 154′, 156′ may include a driven screen layer (e.g. copper mesh layer) formed therein for negating stray capacitance. As illustrated, each pair of inner electrode pads 142A/B, 142A′B and each pair of outer electrode pads 142C/D, 142C′/D′ are positioned along the x axis either side of longitudinal axis “A” whereby rotation of handle 150 relative to shaft 130 around axis “A′” will result in movement of the electrode pads in each adjacent pair moving in opposed direction along the y axis.

Resilient coupling between handle 150 and shaft 130 is achieved by means of: a first pair of inner resilient dielectric layer pads 146A, 146B each having a first side bonded to the first inner PCB 154 to cover a respective inner electrode pad 142A, 142B and second side bonded to shaft 130; a second set of inner resilient dielectric layer pads 146A′, 146B′ each having a first side bonded to the second inner PCB 156 to cover a respective inner electrode pad 142A′, 142B′ and second side bonded to shaft 130; a first pair of outer resilient dielectric layer pads 146C, 146D each having a first side bonded to the first outer PCB 154′ to cover a respective outer electrode pad 142C, 142D and a second side bonded to the second side of the first inner PCB 154; and a second pair of outer resilient dielectric layer pads 146C′, 146D′ each having a first side bonded to the second outer PCB 156′ to cover a respective outer electrode pad 142C′, 142D′ and a second side bonded to the second side of the second inner PCB 156.

Stabilising discs 138, 139 mounted on shaft 130 are trapped in recesses 158, 159 respectively formed in body 152 to prevent movement of handle 150 relative to shaft 130 in the z axis direction whilst allowing sufficient edge clearance for rotation of handle 150 relative to shaft 130 around axis “A′” and displacement of handle 150 relative to shaft 130 along the y axis.

A touch capacitor 160 is additionally located on an uppermost part of body 152 configured to detect the presence of the user's hand on handle 150.

Operation of vehicle control device 110 is substantially as for vehicle control device 10, but with the first and second pairs of outer capacitor assemblies 140C-D/140C′-D′ providing the redundancy rather than lower pairs of capacitor assemblies 40C-D/40C′-D′.

FIG. 4 shows an alternative form of a vehicle control device 210 in which a first set of capacitor assemblies 240A-D are provided to measure a force input in a first linear direction (i.e. along the y axis) and a second set of capacitor assemblies 240A′-D′ are provided to measure a force input in a second linear direction normal to the first lienar dirction (i.e. along the x axis). Sensor redundancy may be provided in accordance with either of the first or second embodiments described above.

Other configurations are possible, for example a 3 lobed, 6 element arrangement.

Whilst the invention has been described in the above embodiments in the context of a capacitance sensor device, the sensing elements can be such devices as strain gauge elements instead of capacitors. However, the capacitor has the advantages that it is extremely robust mechanically and electrically, and is low-cost and simple to construct.

As the skilled person would appreciate, it would also be possible to additionally add a z axis force sensor (e.g. capacitive or using strain gauge) if required.

1. A controller for converting a force applied by a user in at least one direction into an output indicative of the force applied, comprising:
a support comprising a first part of a capacitor assembly; and
a user-engageable part resiliently coupled to the support and comprising a second part of the capacitor assembly, wherein movement of the user-engageable part relative to the support varies the capacitance of the capacitor assembly;
characterised in that the user-engageable part is substantially immovable relative to the support in the at least one direction.

2. A controller according to claim 1, wherein linear displacement of the user-engageable part relative to the support is limited to a range of less than 1 mm.

3. A controller according to claim 1, wherein the first part of the capacitor comprises a first conductor region of the capacitor.

4. A controller according to claim 1, wherein the second part of the capacitor comprises a second conductor region of the capacitor.

5. A controller according to claim 1, wherein the support comprises an elongate section having a first end to which the user-engageable part is resiliently coupled.

6. A controller according to claim 1, wherein the user-engageable part comprises a substantially circular or substantially spherical body configured to be grasped by a user's hand.

7. A controller according to claim 1, wherein the first and second conductor regions are separated by a resilient dielectric layer.

8. A controller according to claim 1, wherein the resilient coupling between the user-engageable part and the support may be provided by an external resilient force.

9. A controller according to claim 1, wherein the user-engageable part is configured to additionally convert a force applied by a user in a further direction into an output indicative of the force applied in the further direction and the user-engageable part is substantially immovable relative to the support in the further direction.

10. A controller according to claim 1, wherein the first-defined direction is a linear direction and the further direction is a rotary direction.

11. A controller according to claim 1, wherein the support further comprises a first part of a second capacitor assembly and the user-engageable part comprises a second part of the second capacitor assembly.

12. A controller according to claim 1, wherein the support further comprises a first part of a third capacitor assembly and the user-engageable part comprises a second part of the third capacitor assembly, with the third capacitor being spaced from the first capacitor assembly in the first direction.

13. A controller according to claim 1, wherein the support further comprises a first part of a fourth capacitor assembly and the user-engageable part comprises a second part of the fourth capacitor assembly, with the fourth capacitor being spaced from the second capacitor assembly in the first direction.

14. A vehicle control device comprising a controller for converting a force applied by a user in at least one direction into an output indicative of the force applied, the controller comprising:
a support; and
a user-engageable part resiliently coupled to the support, wherein movement of the user-engageable part relative to the support varies an electrical property of a part of the controller;
characterised in that the user-engageable part is substantially immovable relative to the support in the at least one direction.

15. A vehicle control device according to claim 14, wherein linear displacement of the user-engageable part relative to the support is limited to a range of less than 1 mm.

16. A vehicle control device according to claim 14, wherein the controller is a controller as previously defined in claim 1.

17. A vehicle control device according to claim 14, wherein the controller includes a strain gauge having an electrical resistance that changes with the position of the user-engageable part relative to the support.

18. A vehicle control device according to claim 14, wherein the controller is configured to detect the presence of the user's hand on the user-engageable part.

19. A vehicle control device according to claim 18, wherein the controller is configured to sustain a last output level applied by a user for as long as the presence of the user's hand is detected on the user-engageable part.

20. A vehicle control device according to claim 19, wherein the output level is sustained until a subsequent force greater than the last force is applied in the same direction as the last force or until a subsequent force in an opposed direction to the last force is applied. In the case of a subsequent force applied in an opposed direction to the last force, the output may be reduced at a rate proportional to the subsequent force applied.

21. A vehicle control device according to claim 18, wherein in response to detecting removal of a user's hand from the user-engageable part the output is gradually reduced.

22. A vehicle control device according to claim 14, wherein the vehicle control device is configured to generate a steering output in response to a force applied in a rotary direction.

23. A vehicle control device according to claim 14, wherein the vehicle control device is configured to generate a tractive force demand output in response to a rearward force.

24. A vehicle control device according to claim 14, wherein the vehicle control device is configured to generate a breaking force demand output in response to a force in a forward direction.

25. A vehicle control device according to claim 14, wherein the vehicle control device is configured to generate both a positive output indicative of a force input in a first direction and a negative output indicative of a force input in a direction opposed to the first direction.

26. A vehicle control device according to claim 21, wherein return of the user's hand to the user-engageable part causes the outputs to stay at the levels that existed immediately prior to the return of the user's hand.
